(19) United States
(12) Patent Application Publication
(10) Pub. No.: US 2026/0158950 A1
(43) Pub. Date: Jun. 11, 2026

(54) TERMINAL SEAT AND CHARGING TERMINAL SET HAVING THE SAME

(71) Applicant: METAL INDUSTRIES RESEARCH AND DEVELOPMENT CENTRE, Kaohsiung (TW)

(72) Inventors: Chun-Chieh CHIU, Kaohsiung (TW); Hsien-Ju WU, Kaohsiung (TW); Tai-Chang CHEN, Kaohsiung (TW); Mei-Jung CHEN, Kaohsiung (TW); Jinn-Feng JIANG, Kaohsiung (TW)

(21) Appl. No.: 18/969,669

(22) Filed: Dec. 5, 2024

(51) Int. Cl. B60L 53/302; B60L 53/16; H01R 13/631

(52) U.S. Cl. CPC B60L 53/302; B60L 53/16; H01R 13/631

(57) ABSTRACT

A charging terminal set includes a terminal seat and a terminal plug detachably connected to the terminal seat. The terminal seat includes a base portion and a plurality of resilient ribs extending from the base portion along a direction of an axis and spaced apart from each other. Each resilient rib has an open end opposite to the base portion, a first frustoconical surface proximate to the open end, and a second frustoconical surface proximate to the first frustoconical surface and disposed between the first frustoconical surface and the base portion. For each resilient rib, the second frustoconical surface defines a second caliber not smaller than a first caliber of the first frustoconical surface. The terminal seat is in surface contact with the terminal plug through one of the first frustoconical surface, the second frustoconical surface, and a combination thereof of each of the resilient ribs.

### FIELD

The present disclosure relates to a terminal set, and more particularly to a charging terminal set having a terminal seat.

### BACKGROUND

Referring to FIG. 1, a leaf spring-based conventional terminal set 1 includes a terminal seat 11, and a terminal plug 12 detachably inserted into the terminal seat 11. The terminal seat 11 includes a plurality of resilient ribs 111 surrounding an axis (L) and defining an insertion hole 110 that has an open end and a blind end opposite to the open end, and two retaining rings 112 surrounding the resilient ribs 111 and disposed adjacent to the open end of the insertion hole 110. In this way, the resilient ribs 111 are constrained by the retaining rings 112, and clamp the terminal plug 12 with a biasing force of the resilient ribs 11. The terminal plug 12 extends into the insertion hole 110 through the open end such that the terminal plug 12 is removably and electrically connected to the terminal seat 11.

Since a caliber of the insertion hole 110 gradually decreases from the blind end to the open end, when the terminal plug 12 is inserted into the insertion hole 110, the resilient ribs 111 are expanded outwardly and are in linear contact with a portion of the terminal plug 12 that has a diameter complementary to the caliber of the insertion hole 110.

However, according to the resistance formula R=ρ×l/A, where R represents a resistance, ρ represents an electrical resistance of a conductor, l represents a length of the conductor, and A represents a cross-sectional area of the conductor, given that a length (l) of the conductor is constant, a resistance (R) of the conductor is in negative correlation with the cross-sectional area (A). That is to say, when the cross-sectional area (A) of the conductor is decreased, the resistance (R) of the conductor is increased.

In an example, the terminal seat 11 is mounted on a charging gun (not shown) for charging electric vehicles, and the terminal plug 12 is mounted to an electric vehicle (not shown) and complies with international standards IEC 62196.

TABLE 1

| | | |
|---|---|---|
| Electric current (Ampere) | 500 | 300 |
| Maximum stress exerted on a base | 205.32 | 199.48 |
| portion of each of the resilient ribs | | |
| (megapascal, MPa) | | |
| Contact area (mm²) | 2.718 | 2.602 |
| Temperature of a handle of a charging | 64.92 | 56.28 |
| gun (° C.) | | |

Referring to Table 1, in a case where an input electric current is 500 ampere and is supplied for 126 seconds, without using a water cooling mechanism, a maximum temperature of a handle of the charging gun is up to 64.92° C., which exceeds a regulatory safety limit of 60° C. In another case where the input electric current is 300 ampere and is supplied for 126 seconds, a maximum temperature of the handle of the charging gun is also up to 56.28° C., which is approaching the regulatory safety limit.

Since inner and outer surfaces of each of the resilient ribs 111 are both flat surfaces, when the resilient ribs 111 are expanded outwardly as a result of the insertion of the terminal plug 12, a contact area between the terminal seat 11 and the terminal plug 12 of each of the above examples is merely 2.718 mm² or 2.602 mm², which is relatively small. Consequently, a majority of stress is exerted on a base portion of each of the resilient ribs 111 adjacent to the blind end of the insertion hole 110. As shown in Table 1, the maximum stress in each of the above examples is 205.32 MPa or 199.48 MPa, which adversely affects lifespan of the conventional terminal set 1. In addition, the contact area between the terminal seat 11 and the terminal plug 12 of each of the above examples may be considered as the cross-sectional area (A) in the resistance formula, such that a relatively small contact area causes a relatively large resistance, thereby increasing the temperature of the handle of the charging gun and reducing charging efficiency of the electric vehicle.

### SUMMARY

Therefore, an object of the disclosure is to provide a terminal seat that can alleviate at least one of the drawbacks of the prior art.

According to an aspect of the present disclosure, a terminal seat adapted to be detachably connected to a terminal plug is disclosed. The terminal seat includes a base portion and a plurality of resilient ribs. The plurality of resilient ribs extend from the base portion along a direction of an axis. The plurality of resilient ribs surround the axis, define an insertion hole, and are spaced apart from each other. The insertion hole is adapted to receive the terminal plug therein, and has a caliber decreasing gradually from the base portion along the axis. The plurality of resilient ribs are adapted for clamping the terminal plug thereamong. Each of the plurality of resilient ribs has an open end opposite to the base portion, a first frustoconical surface proximate to the open end, and a second frustoconical surface proximate to the first frustoconical surface and disposed between the first frustoconical surface and the base portion. For each of the plurality of resilient ribs, the first frustoconical surface defines a first caliber that gradually decreases from the base portion toward the open end, and the second frustoconical surface defines a second caliber that gradually decreases from the base portion toward the open end and that is not smaller than the first caliber. The terminal seat is adapted to be in surface contact with the terminal plug through one of the first frustoconical surface, the second frustoconical surface, and a combination thereof of each of the plurality of resilient ribs.

According to another aspect of the present disclosure, a charging terminal set includes the terminal seat as described above, and a terminal plug detachably and electrically connected to the terminal seat, clamped by the plurality of resilient ribs, in contact with one of the first frustoconical surface, the second frustoconical surface and a combination thereof of each of the plurality of resilient ribs, and spaced apart from another one of the first frustoconical surface and the second frustoconical surface of each of the plurality of resilient ribs.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view of a conventional terminal set.

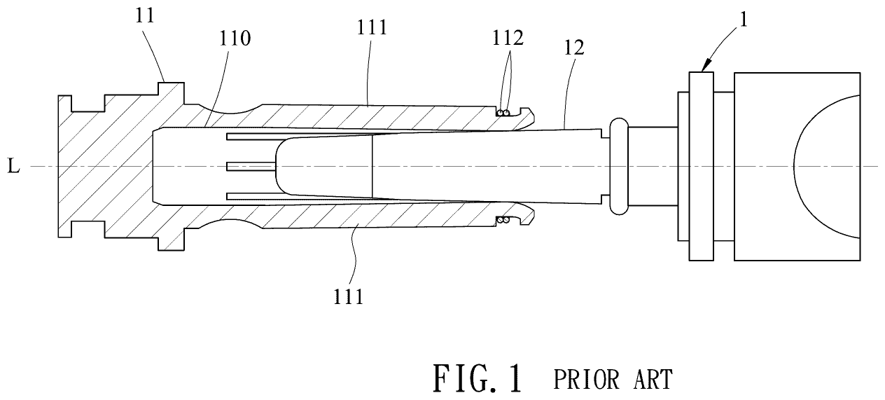

FIG. 2 is a schematic sectional view illustrating an embodiment of a charging terminal set that includes a plurality of terminal seats and a plurality of terminal plugs according to the present disclosure adapted to be mounted to an electric vehicle and a charging gun for charging the electric vehicle.

FIG. 3 is a perspective view of one of the terminal seats.

FIG. 4 is a front view of one of the terminal seats.

FIG. 5 is a sectional view taken along line V-V in FIG. 4.

FIG. 6 is a partly enlarged sectional view of FIG. 5, illustrating structure of one of the terminal seats.

FIG. 7 is a schematic sectional view of the embodiment, illustrating one of the terminal plugs that is not worn being inserted into and electrically connected to one of the terminal seats.

FIG. 8 is a schematic sectional view similar to FIG. 7, but illustrating that one of the terminal plugs that is worn being inserted into the one of the terminal seats.

FIG. 9 is a plot diagram illustrating a relationship between an outer diameter of one of the terminal plugs and a maximum contact area between the one of the terminal plugs and the one of the terminal seats.

FIG. 10 is a plot diagram of first to fourth reference examples of the embodiment, illustrating a relationship between a contact area between one of the terminal plugs and the one of the terminal seats and a displacement of the one of the terminal plugs of each of the first to the fourth reference examples.

FIG. 11 is a diagram illustrating a distribution of stress exerted on the charging terminal set shown in FIG. 7.

FIG. 12 is a diagram illustrating a distribution of stress exerted on the charging terminal set shown in FIG. 8.

FIG. 13 is a diagram illustrating a temperature distribution of the one of the terminal seats mounted to the charging gun.

FIG. 14 is a plot diagram illustrating a relationship between a contact area between a terminal plug and a terminal seat of a conventional terminal set and a displacement of the terminal plug.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

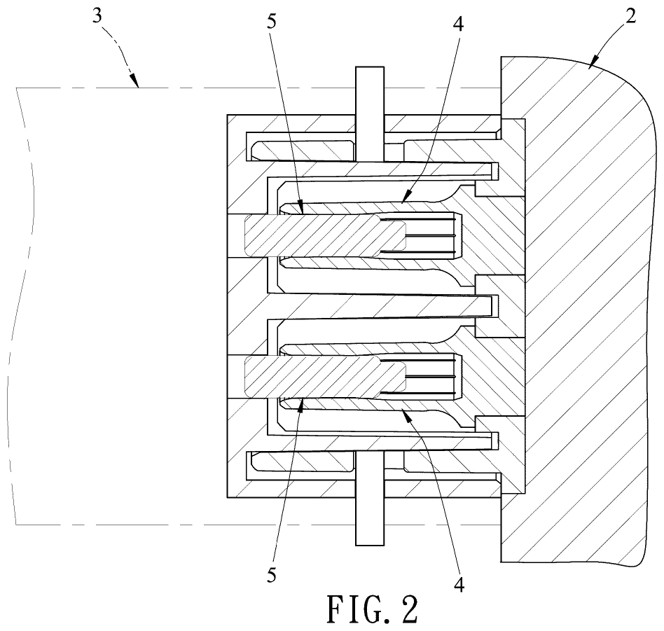

Referring to FIG. 2, an embodiment of a charging terminal set according to the present disclosure is adapted for charging an electric vehicle 3 by electricity from a charging gun 2. In this embodiment, the charging terminal set includes two terminal seats 4 and two terminal plugs 5. It should be noted that the numbers of the terminal plugs 5 and the terminal seats 4 may be modified in other embodiments as long as the numbers thereof are the same. Therefore, the number of the terminal plugs 5 and the terminal seats 4 are not limited to two, and may be one or three or more in other variations of this embodiment.

It should be noted that since the charging gun 2 and the electric vehicle 3 are not the main features of the present disclosure, further details of the same are omitted. In addition, since the structures of the terminal seats 4 are identical and the structures of the terminal plugs 5 are identical, only one of the terminal seats 4 and a respective one of the terminal plugs 5 will be described in the following description.

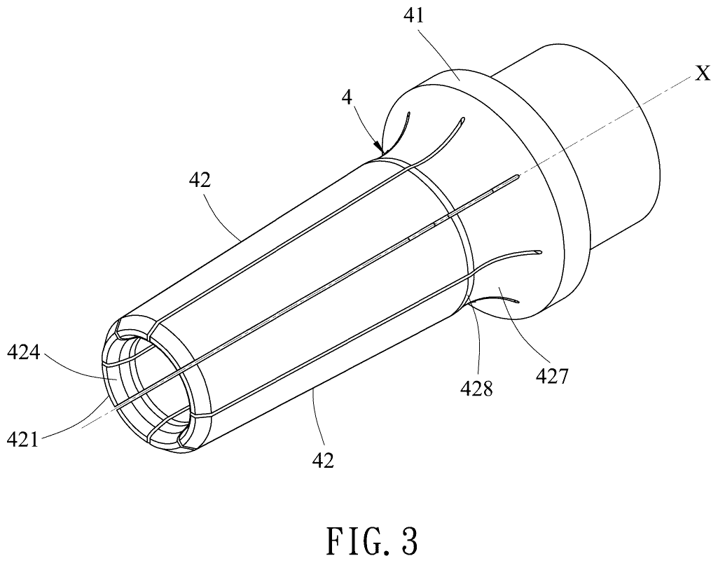

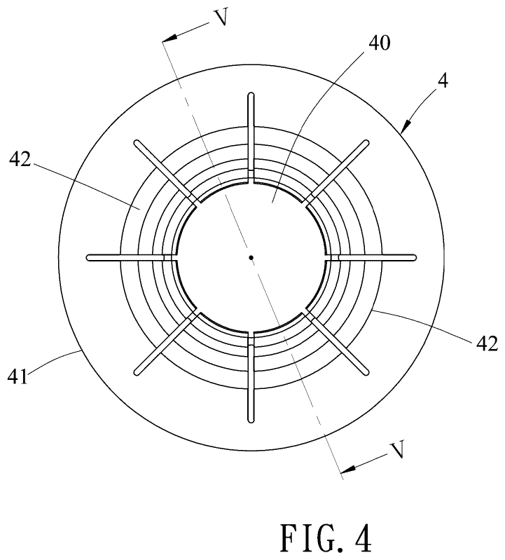

Referring to FIGS. 3 to 6, the terminal seat 4 includes a base portion 41, and a plurality of resilient ribs 42 extending from the base portion 41 along an axis (X) and spaced apart from each other in a circumferential direction surrounding the axis (X). In this embodiment, the number of the resilient ribs 42 is eight.

The resilient ribs 42 surround the axis (X) and define an insertion hole 40 for receiving the terminal plug 5 (see FIG. 2) therein. The resilient ribs 42 clamp the terminal plug 5 thereamong. Each of the resilient ribs 42 has an open end 421 opposite to the base portion 41, a first frustoconical surface 422 proximate to the open end 421, a second frustoconical surface 423 proximate to the first frustoconical surface 422 and disposed between the first frustoconical surface 422 and the base portion 41, a guiding inclined surface 424 interconnecting the open end 421 and the first frustoconical surface 422, a planar surface 425 connected to the base portion 41, parallel to the axis (X), and disposed between the second frustoconical surface 423 and the base portion 41, a third frustoconical surface 426 proximate to the second frustoconical surface 423 and disposed between the planar surface 425 and the second frustoconical surface 423, a first curved surface 427 proximate to the base portion 41 and being a concave surface, and a second curved surface 428 connected to one end of the first curved surface 427 that is opposite to the base portion 41 and being a convex surface. The insertion hole 40 has a caliber decreasing gradually from the base portion 41 to the first frustoconical surface 422 along the axis (X).

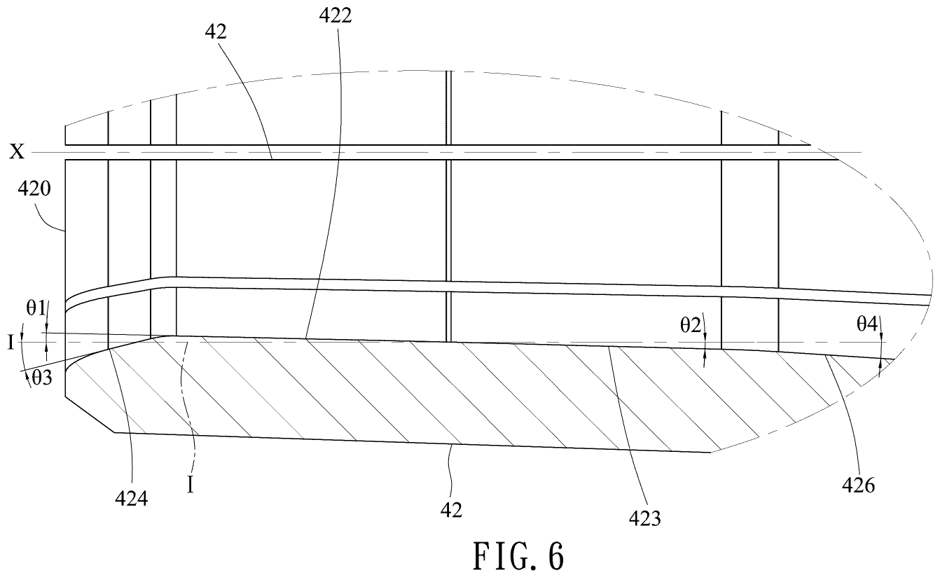

It should be noted that since the structures of the resilient ribs 42 are the same, only one of the resilient ribs 42 is described in the following description for the sake of brevity. In this embodiment, the first frustoconical surface 422 defines a first caliber that gradually decreases from the base portion 41 toward the open end 421, and a caliber change rate of the first frustoconical surface 422 ranges from 3% to 3.5%. Specifically, the caliber change rate of the first frustoconical surface 422 is obtained by dividing a difference between a caliber of a starting end of the first frustoconical surface 422 and a caliber of a terminating end of the first frustoconical surface 422 that is proximate to the base portion 41 by the caliber of the starting end of the first frustoconical surface 422 and multiplied by 100%. In this embodiment, the first caliber ranges from, e.g., 7.51 mm to 7.77 mm, and the caliber change rate of the first frustoconical surface 422 is equal to (7.77−7.51)/7.51×100%=3.46%. As shown in FIG. 6, the first frustoconical surface 422 cooperates with an imaginary line (I) parallel to the axis (X) to define a first included angle (θ1) and has a first length (L1) in the direction of the axis (X). In this embodiment, the first length (L1) is 5.8 mm and the first included angle (θ1) is 2.6 degrees.

In this embodiment, the second frustoconical surface 423 defines a second caliber that gradually decreases from the base portion 41 toward the open end 421, a caliber change rate of the second frustoconical surface 423 is greater than the caliber change rate of the first frustoconical surface 422, and the caliber change rate of the second frustoconical surface 423 ranges from 2.8% to 3.6%. The caliber change rate of the second frustoconical surface 423 is obtained by dividing a difference between a caliber of a starting end of the second frustoconical surface 423 and a caliber of a terminating end of the second frustoconical surface 423 that is proximate to the base portion 41 by the caliber of the starting end of the second frustoconical surface 423 and multiplied by 100%. In this embodiment, the second caliber ranges from, e.g., 7.78 mm to 8 mm, and the caliber change rate of the second frustoconical surface 423 is equal to (8−7.78)/7.78×100%=2.8%. The second frustoconical surface 423 cooperates with the imaginary line (I) to define a second included angle (θ2) and has a second length (L2) in the direction of the axis (X). In this embodiment, the second length (L2) is 5.8 mm and the second included angle (θ2) is 3.1 degrees.

The guiding inclined surface 424 defines a flared opening 420 having a flared caliber that gradually increases from the first frustoconical surface 422 toward the open end 421 along the axis (X). In this embodiment, the guiding inclined surface 424 has a caliber change rate that ranges from 12% to 13%. Specifically, the caliber change rate of the guiding inclined surface 424 is obtained by dividing a difference between a caliber of a starting end of the guiding inclined surface 424 and a caliber of a terminating end of the guiding inclined surface 424 that is proximate to the base portion 41 by the caliber of the starting end of the guiding inclined surface 424 and multiplied by 100%. In this embodiment, the first caliber ranges from, e.g., 7.51 mm to 8.6 mm, and the caliber change rate of the guiding inclined surface 424 is equal to (8.6−7.51)/8.6×100%=12.67%. The guiding inclined surface 424 cooperates with the imaginary line (I) parallel to the axis (X) to define a third included angle (θ3) and has a third length (L3) in the direction of the axis (X). In this embodiment, the third length (L3) is 2.5 mm and the third included angle (θ3) is 28.7 degrees.

In this embodiment, the planar surface 425 defines a caliber equal to 9 mm, and the planar surface 425 is substantially parallel to the axis (X).

A caliber change rate of the third frustoconical surface 426 is greater than the caliber change rate of the second frustoconical surface 423 and smaller than the caliber change rate of the guiding inclined surface 424. In this embodiment, the third frustoconical surface 426 defines a third caliber that gradually decreases from the base portion 41 toward the open end 421, and the caliber change rate of the third frustoconical surface 426 ranges from 8.2% to 9.2%. Specifically, the caliber change rate of the third frustoconical surface 426 is obtained by dividing a difference between a caliber of a starting end of the third frustoconical surface 426 and a caliber of a terminating end of the third frustoconical surface 426 that is proximate to the base portion 41 by the caliber of the starting end of the third frustoconical surface 426 and multiplied by 100%. In this embodiment, the third caliber of the third frustoconical surface 426 ranges from, e.g., 8.16 mm to 8.87 mm, and the caliber change rate of the third frustoconical surface 426 is equal to (8.87−8.16)/8.16×100%=8.7%. The third frustoconical surface 426 cooperates with the imaginary line (I) parallel to the axis (X) to define a fourth included angle (θ4) and has a fourth length (L4) in the direction of the axis (X). In this embodiment, the fourth length (L4) is 4.9 mm and the fourth included angle (θ4) is 7.47 degrees.

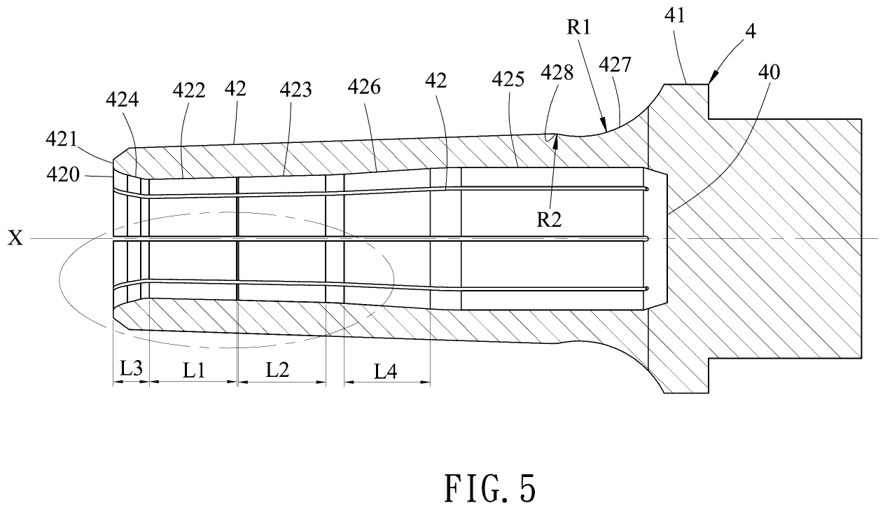

As shown in FIG. 5, the first curved surface 427 defines a first radius corner (R1). In this embodiment, a radius of the first radius corner (R1) ranges from 5.5 mm to 6.5 mm, which is also known as 5.5 R to 6.5 R. In one embodiment, the radius of the first radius corner (R1) is 6.04 mm, which is also known as 6.04 R.

The second curved surface 428 defines a second radius corner (R2) that is smaller than the first radius corner (R1). In this embodiment, a radius of the second radius corner (R2) ranges from 2.5 mm to 3.5 mm, which is also known as 2.5 R to 3.5 R. In one embodiment, the radius of the second radius corner (R2) is 3 mm, which is also known as 3 R.

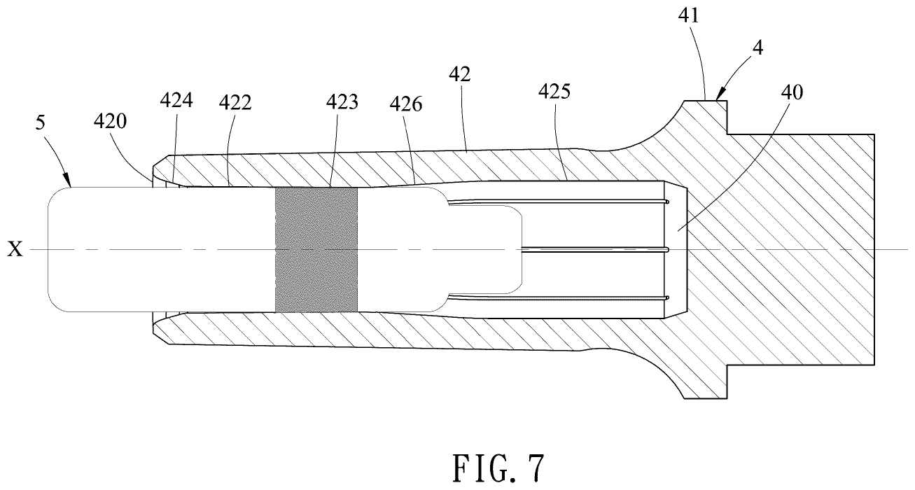

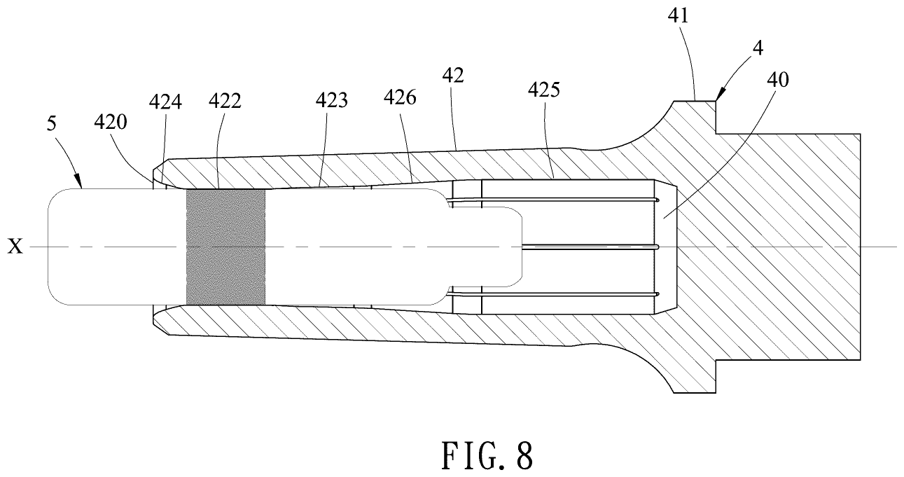

Further referring to FIGS. 7 and 8, the terminal plug 5 is detachably and electrically connected to the terminal seat 4, and is clamped by the resilient ribs 42.

Since plugging and unplugging processes cause wear to the terminal plug 5, an outer diameter of the terminal plug 5 gradually decreases over time. In one example, an original outer diameter of the terminal plug 5 is 7.97 mm, and a worn outer diameter of the terminal plug 5 is 7.85 mm, so the outer diameter of the terminal plug 5 ranges from 7.85 mm to 7.97 mm.

As shown in FIG. 7, when the terminal plug 5 that is not worn is inserted into the insertion hole 40 through the flared opening 420 along the axis (X), the terminal plug 5 sequentially pushes the guiding inclined surface 424 and the first frustoconical surface 422 to expand the resilient rib 42. As the terminal plug 5 gradually extends into the insertion hole 40 and pushes at least one portion of the second frustoconical surface 423, the second caliber of the at least one portion of the second frustoconical surface 423 is expanded to be the same as the outer diameter of the terminal plug 5. At this position, the resilient rib 42 is expanded outwardly and deforms, and the base portion 41 bends in a direction away from the axis (X), such that at least 90% of an area of the second frustoconical surface 423 is in contact with the terminal plug 5 as indicated by a gray block shown in FIG. 7. Furthermore, at this position, the first frustoconical surface 422 is spaced apart from the terminal plug 5, and the guiding inclined surface 424 and the third frustoconical surface 426 are also spaced apart from the terminal plug 5 because the flared caliber and the third caliber that are respectively defined by the guiding inclined surface 424 and the third frustoconical surface 426 are inherently greater than the outer diameter of the terminal plug 5 that is not worn, and the third included angle (θ3) or the fourth included angle (θ4) is defined between the guiding inclined surface 424 or the third frustoconical surface 426 and the imaginary line (I).

As shown in FIG. 8, when the terminal plug 5 that is worn is inserted into the insertion hole 40 through the flared opening 420 along the axis (X), the resilient rib 42 is also expanded and deforms. As the terminal plug 5 gradually extends into the insertion hole 40 and pushes at least one portion of the first frustoconical surface 422, the first caliber of the at least one portion of the first frustoconical surface 422 is expanded to be the same as the outer diameter of the terminal plug 5, such that at least 90% or close to 100% of an area of the first frustoconical surface 422 is in contact with the terminal plug 5 as indicated by a gray block shown in FIG. 8. At this position, the resilient rib 42 is also expanded outwardly. Since the second caliber of a portion of the second frustoconical surface 423 is greater than the outer diameter of the terminal plug 5 that is worn, the guiding inclined surface 424, the portion of the second frustoconical surface 423, and the third frustoconical surface 426 are spaced apart from the terminal plug 5, and the first frustoconical surface 422 and a remaining portion of the second frustoconical surface 423 are in contact with the terminal plug 5. In some examples, the terminal plug 5 is in contact with only the first frustoconical surface 422 depending on a degree of wear of the terminal plug 5.

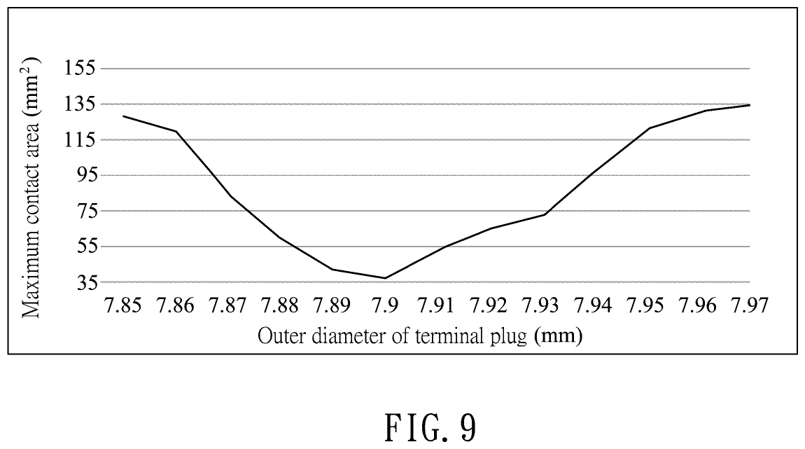

Referring to FIG. 9, a plot diagram illustrates a relationship between the outer diameter of the terminal plug 5 and a contact area between the terminal plug 5 and the terminal seat 4. In this example, the outer diameter of the terminal plug 5 ranges from 7.85 mm to 7.97 mm. In a case where the outer diameter of the terminal plug 5 is 7.9 mm, the terminal plug 5 is in contact with a portion of the first frustoconical surface 422 and a portion of the second frustoconical surface 423, and the contact area thereamong is up to 38.76 mm² and is the smallest as compared to the contact area between the terminal plug 5 and the terminal seat 4 when the outer diameter of the terminal plug 5 is other than 7.91 mm. In another case where the outer diameter of the terminal plug 5 is 7.97 mm, the terminal plug 5 is in complete contact with the second frustoconical surface 423, and the contact area between the terminal plug 5 and the terminal seat 4 is up to 134.7 mm². In still another case where the outer diameter of the terminal plug 5 is 7.85 mm, the terminal plug 5 is in complete contact with the first frustoconical surface 422, and the contact area therebetween is up to 125.28 mm².

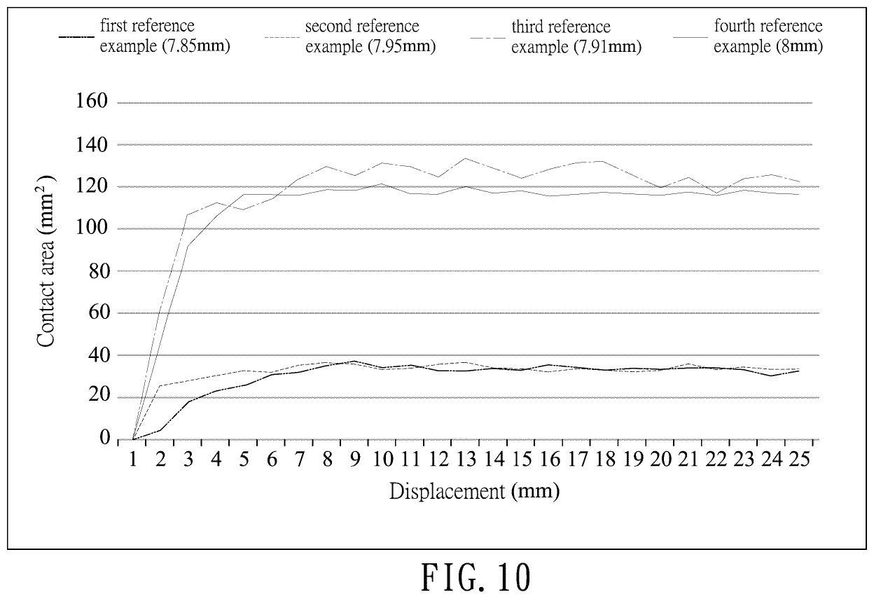

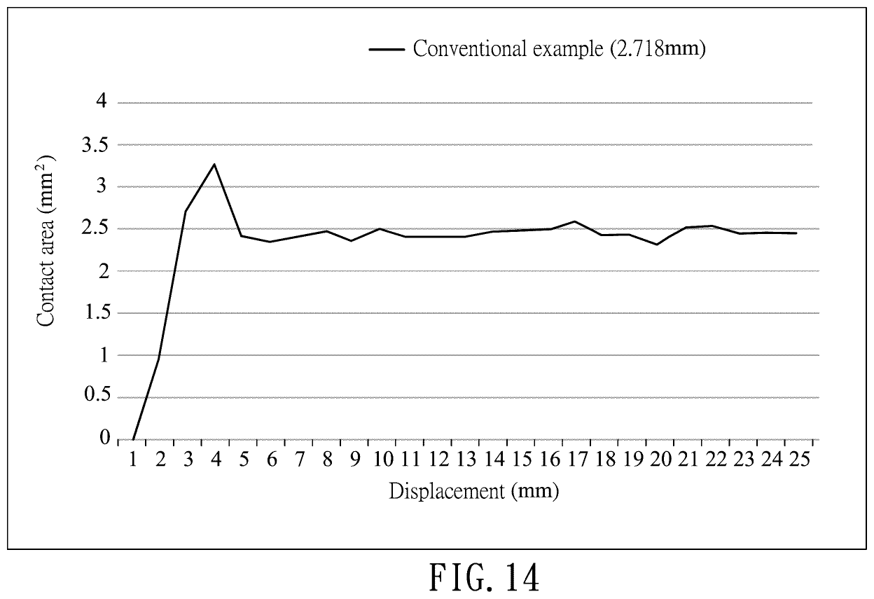

Further referring to FIG. 10, first to fourth reference examples of the present disclosure illustrating the terminal plug 5 having different outer diameters are shown. FIG. 10 illustrates a relationship between a contact area between the terminal plug 5 and the terminal seat 4 and a displacement of the terminal plug 5 relative to the terminal seat 4 of the first to the fourth reference examples. In each of the first to the fourth reference examples, a process of a change in the contact area between the terminal plug 5 and the terminal seat 4 from drastically increasing from zero to being gradually stabilized is relatively smooth. Specifically, although a change in stress exerted on the terminal seat 4 is relatively large at an early stage of the insertion of the terminal plug 5 into the terminal seat 4, the change in the stress is gradually stabilized. FIG. 14 is a conventional example illustrating a relationship between a contact area between a terminal plug and a terminal seat of a conventional terminal set and a displacement of the terminal plug relative to the terminal seat of the conventional terminal set. During an insertion of the terminal plug into the terminal seat, a contact area between the terminal plug and the terminal seat is drastically increased first and then is drastically decreased, thereby resulting in a relatively large change in stress exerted on the terminal seat, and the terminal plug may be worn easily. It is evident that, as compared to the conventional terminal set of the conventional example, the contact area of each of the first to the fourth reference examples of the present disclosure is greatly increased by 140% to 490%. In this way, since the contact area between the terminal plug 5 and the terminal seat 4 of each of the first to the fourth reference examples is larger than that of the conventional terminal set, a resistance generated during charging of the electric vehicle 3 using the embodiment of the present disclosure is lower than a resistance generated in the conventional terminal set. Additionally, the degree of wear of the terminal plug 5 may be reduced, thereby prolonging the lifespan of the charging terminal set of the present disclosure.

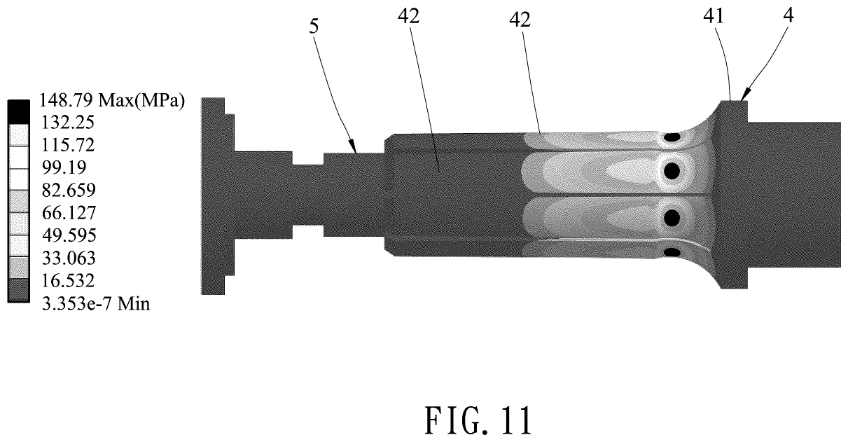

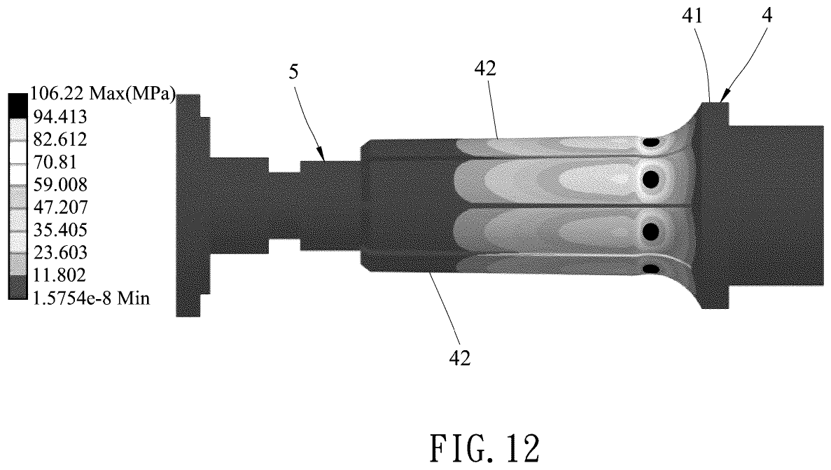

Furthermore, through the design of the first curved surface 427 and the second curved surface 428, elasticity of the resilient rib 42 may be increased and the stress exerted on the terminal seat 4 may be reduced. FIGS. 11 and 12 are two diagrams respectively illustrating distributions of the stress exerted on the charging terminal set shown in FIGS. 7 and 8. In a case where a minimum contact area between the terminal plug 5 and the terminal seat 4 of the terminal set shown in FIG. 12 is 38.76 mm², a majority of the stress is exerted at a location adjacent to the base portion 41 of the terminal seat 4, and the maximum stress is 106.22 megapascals (MPa). In another case where a maximum contact area between the terminal plug 5 and the terminal seat 4 of the terminal set shown in FIG. 11 is up to 134.7 mm², the majority of the stress is also exerted at a location adjacent to the base portion 41, and the maximum stress is, e.g., 148.79 MPa. It can be appreciated that from the above description and Table 1 in the background section of the disclosure, the stress generated in the charging terminal set of the present disclosure is smaller than that generated in the conventional terminal set. Furthermore, the fatigue life of the charging terminal set of the present disclosure is up to about 96,693 times of insertion of the terminal plug 5 into the terminal seat 4, which is significantly greater than a regulatory limit of 10,000 times.

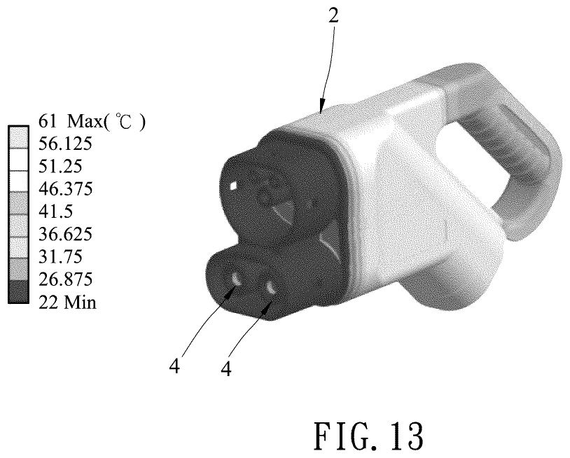

Referring to FIGS. 2 and 13, when the charging gun 2 is electrically connected to the electric vehicle 3 and is charging the electric vehicle 3, in a case where an input electric current of the charging gun 2 is 500 ampere and is supplied for 126 seconds, by virtue of the structural design of the terminal seat 4 that increases the contact area between the terminal seat 4 and the terminal plug 5 and thereby decreases a resistance generated during charging, the maximum temperature of the charging gun 2 is 41.38° C., which falls within the regulatory safety limit of 60° C. and which is much lower than the temperature of the handle of the charging gun described in the background section of the disclosure. In addition, according to the resistance formula, as compared to the conventional terminal set that has a maximum contact area of 2.718 mm², which is much smaller than the resistance generated in the present disclosure, a reduction rate of a resistance generated in the present disclosure is about 93% to 98%.

Through the above description, the advantages of the embodiment of the present disclosure can be summarized as follows.

First, by virtue of the structural design of the caliber of the insertion hole 40 gradually decreasing to the first frustoconical surface 422, and the design of the first frustoconical surface 422 and the second frustoconical surface 423, the terminal plug 5 that is not worn is in surface contact with the second frustoconical surface 423, and the terminal plug 5 that is worn is in surface contact with the first frustoconical surface 423. In this way, the resilient ribs 42 of the terminal seat 4 may stably clamp the terminal plug 5 thereamong regardless of whether the terminal plug 5 is worn or not.

Second, in the present disclosure, the terminal seat 4 and the terminal plug 5 are in surface contact with each other and the contact area therebetween is increased as compared to the conventional terminal set, thereby reducing the resistance generated during charging, and reducing the temperature to comply with the regulatory safety limit.

Third, through the design of the first curved surface 427 and the second curved surface 428, the elasticity of the resilient rib 42 may be increased and the stress exerted on the terminal seat 4 may be reduced. Additionally, the fatigue life of the charging terminal set of the present disclosure is up to about 96,693 times of insertion of the terminal plug 5, which is significantly greater than a regulatory limit of 10,000 times.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A terminal seat adapted to be detachably connected to a terminal plug, said terminal seat comprising:
a base portion; and
a plurality of resilient ribs extending from said base portion along a direction of an axis, said plurality of resilient ribs surrounding the axis and spaced apart from each other, said plurality of resilient ribs defining an insertion hole, said insertion hole being adapted to receive the terminal plug therein and having a caliber decreasing gradually from said base portion along the axis, said plurality of resilient ribs being adapted for clamping said terminal plug thereamong, each of said plurality of resilient ribs having
an open end opposite to said base portion,
a first frustoconical surface proximate to said open end, and
a second frustoconical surface proximate to said first frustoconical surface and disposed between said first frustoconical surface and said base portion, said first frustoconical surface defining a first caliber that gradually decreases from said base portion toward said open end, said second frustoconical surface defining a second caliber that gradually decreases from said base portion toward said open end and that is not smaller than said first caliber, said terminal seat being adapted to be in surface contact with said terminal plug through one of said first frustoconical surface, said second frustoconical surface, and a combination thereof of each of said plurality of resilient ribs.

2. The terminal seat as claimed in claim 1, wherein, for each of said resilient ribs, a caliber change rate of said second frustoconical surface is greater than a caliber change rate of said first frustoconical surface, the caliber change rate of each of said first frustoconical surface and said second frustoconical surface being obtained by dividing a difference between a caliber of a starting end of each of said first frustoconical surface and said second frustoconical surface and a caliber of a terminating end of each of said first frustoconical surface and said second frustoconical surface that is proximate to said base portion by the caliber of said starting end of each of said first frustoconical surface and said second frustoconical surface and multiplied by 100%.

3. The terminal seat as claimed in claim 1, wherein, for each of said plurality of resilient ribs, a caliber change rate of said first frustoconical surface ranges from 3% to 3.5%, and a caliber change rate of said second frustoconical surface ranges from 2.8% to 3.6%, the caliber change rate of each of said first frustoconical surface and said second frustoconical surface being obtained by dividing a difference between a caliber of a starting end of each of said first frustoconical surface and said second frustoconical surface and a caliber of a terminating end of each of said first frustoconical surface and said second frustoconical surface that is proximate to said base portion by the caliber of said starting end of each of said first frustoconical surface and said second frustoconical surface and multiplied by 100%.

4. The terminal seat as claimed in claim 1, wherein each of said plurality of resilient ribs further has a first curved surface proximate to said base portion and being a concave surface, and a second curved surface connected to one end of said first curved surface that is opposite to said base portion and being a convex surface, said first curved surface defining a first radius corner, and said second curved surface defining a second radius corner that is smaller than said first radius corner.

5. The terminal seat as claimed in claim 4, wherein, for each of said plurality of resilient ribs, a radius of the first radius corner ranges from 5.5 mm to 6.5 mm, and a radius of the second radius corner ranges from 2.5 mm to 3.5 mm.

6. The terminal seat as claimed in claim 1, wherein each of said plurality of resilient ribs further has a guiding inclined surface interconnecting said open end and said first frustoconical surface, defining a flared opening that has a flared caliber gradually increasing from said first frustoconical surface along the axis to said open end, and having a caliber change rate that ranges from 12% to 13%, the caliber change rate of said flared opening being obtained by dividing a difference between a caliber of a starting end of said flared opening and a caliber of a terminating end of said flared opening that is proximate to said base portion by the caliber of said starting end of said flared opening and multiplied by 100%.

7. The terminal seat as claimed in claim 1, wherein each of said plurality of resilient ribs further has a planar surface that is connected to said base portion, that is parallel to the axis, and that is disposed between said second frustoconical surface and said base portion.

8. The terminal seat as claimed in claim 1, wherein each of said plurality of resilient ribs further has a third frustoconical surface proximate to said second frustoconical surface, disposed between said base portion and said second frustoconical surface, and having a caliber change rate that is greater than a caliber change rate of said second frustoconical surface, and that ranges from 8.2% to 9.2%, the caliber change rate of each of said third frustoconical surface and said second frustoconical surface being obtained by dividing a difference between a caliber of a starting end of each of said third frustoconical surface and said second frustoconical surface and a caliber of a terminating end of each of said third frustoconical surface and said second frustoconical surface that is proximate to said base portion by the caliber of said starting end of each of said third frustoconical surface and said second frustoconical surface and multiplied by 100%.

9. The terminal seat as claimed in claim 8, wherein at least 90% of a total area of said first frustoconical surface or at least 90% of a total area of said second frustoconical surface is configured to contact said terminal plug.

10. A charging terminal set comprising:
said terminal seat as claimed in claim 1; and
a terminal plug detachably and electrically connected to said terminal seat, clamped by said plurality of resilient ribs, in contact with one of said first frustoconical surface and said second frustoconical surface of each of said plurality of resilient ribs, and spaced apart from another one of said first frustoconical surface and said second frustoconical surface of each of said plurality of resilient ribs.
